(19) United States
(12) Patent Application Publication
(10) Pub. No.: US 2024/0270178 A1
(43) Pub. Date: Aug. 15, 2024

(54) SENSOR ASSEMBLY

(71) Applicant: Ford Global Technologies, LLC, Dearborn, MI (US)

(72) Inventors: Michael Robertson, JR., Garden City, MI (US); Venkatesh Krishnan, Canton, MI (US); Tyler D. Hamilton, Farmington, MI (US); Nicholas Sharpe, Grand Rapids, MI (US); Subba Reddy Boggu, Prakasam Dist (IN)

(73) Assignee: Ford Global Technologies, LLC, Dearborn, MI (US)

(21) Appl. No.: 18/166,507

(22) Filed: Feb. 9, 2023

(51) Int. Cl. B60R 11/00

(52) U.S. Cl. CPC B60R 11/00; B60R 2011/0019; B60R 2011/004

(57) ABSTRACT

An assembly for includes a body panel of a vehicle. The assembly includes a sensor supported by the body panel. The sensor includes a sensor window. The assembly includes a cover fixed relative to the sensor. The cover is positioned to expose at least a portion of the sensor window. The cover is shaped to include a feature that diverts a first flow path of ambient air while the vehicle travels forward. The first flow path is generated along a vehicle-longitudinal axis when the vehicle travels forward.

### BACKGROUND

Autonomous vehicles include a variety of sensors. Some sensors detect internal states of the vehicle, for example, wheel speed, wheel orientation, and engine and transmission variables. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back.

### BRIEF DESCRIPTION OF THE DRAWINGS

FIG. 1 is a perspective view of a vehicle having an assembly having sensors supported by a body of the vehicle.

FIG. 2 is a frontal view of the assembly having sensors for the vehicle.

FIG. 3 is an exploded view of the assembly.

FIG. 4 is a frontal view of a first example of a first sensor having an opening adjacent the first sensor.

FIG. 5A is a frontal view of a second example of the first sensor having a deflector adjacent the first sensor.

FIG. 5B is a bottom view of second example of the first sensor having the deflector adjacent the first sensor.

FIG. 6A is a frontal view of a third example of the first sensor having a duct adjacent the first sensor and a deflector adjacent the first sensor.

FIG. 6B is a top cross-sectional view of the third example of the first sensor having the duct adjacent the first sensor and the deflector adjacent the first sensor.

FIG. 6C is a perspective view of the third example of the first sensor having the duct adjacent the first sensor and the deflector adjacent the first sensor.

### DETAILED DESCRIPTION

An assembly for includes a body panel of a vehicle. The assembly includes a sensor supported by the body panel. The sensor includes a sensor window. The assembly includes a cover fixed relative to the sensor. The cover is positioned to expose at least a portion of the sensor window. The cover is shaped to include a feature that diverts a first flow path of ambient air while the vehicle travels forward. The first flow path is generated along a vehicle-longitudinal axis when the vehicle travels forward.

The feature may be spaced vehicle-forward of the sensor window.

The cover may define a depression, the sensor and the feature being disposed in the depression.

The feature may include an opening vehicle-forward of the sensor window and the opening is positioned relative to the sensor window to divert the first flow path while the vehicle travels forward.

The opening may be positioned such that the first flow path extends into the opening and out of the opening to divert the first flow path away from the sensor window while the vehicle travels forward.

The feature may include a deflector fixed relative to the sensor and spaced vehicle-forward of the sensor. The deflector may be shaped to divert the first flow path away from the sensor window while the vehicle travels forward.

The feature may include a duct elongated along the vehicle-longitudinal axis. The duct may define an inlet vehicle-forward of the sensor window along the vehicle-longitudinal axis and an outlet directed toward the sensor window, the inlet positioned to receive the first flow path.

The outlet may be positioned to divert the first flow path.

The cover may be supported by the body panel. The duct may be between the cover and the body panel.

The assembly may include a baffle disposed in the duct between the inlet and the outlet.

The outlet may be adjacent the sensor window.

The inlet may be spaced vehicle-forward of the sensor window.

The outlet may be between the inlet and the sensor window along the vehicle-longitudinal axis.

The feature may include a deflector fixed relative to the sensor and spaced vehicle-forward of the sensor. The deflector may be shaped to divert airflow away from the sensor window while the vehicle travels forward.

The cover may be supported by the body panel.

The body panel may be a vehicle fender.

The sensor may be a camera.

The feature may divert the first flow path away from the sensor window.

The feature may divert the first flow path toward the sensor window.

The assembly may include a cleaning device defining a cleaning flow path. The first flow path may be transverse to the cleaning flow path.

With reference to the Figures, wherein like numerals indicate like parts throughout the several views, an assembly 10 for a vehicle 12 includes a body panel 14 of a vehicle 12. The assembly 10 includes a sensor 16 supported by the body panel 14. The sensor 16 includes a sensor window 18. The assembly 10 includes a cover 20 fixed relative to the sensor 16. The cover 20 is positioned to expose at least a portion of the sensor window 18. The cover 20 is shaped to include a feature 24 that diverts a first flow path 22 of ambient air while the vehicle 12 travels forward. The first flow path 22 is generated along a vehicle-longitudinal axis L when the vehicle 12 travels forward.

As the vehicle 12 travels forward, the vehicle 12 generates the first flow path 22 over the sensor 16 and the sensor window 18. The shape of the cover 20 including the feature 24 diverts the first flow path 22 while the vehicle 12 travels to aid in other flow paths over the sensor 16 to remain over the sensor window 18. Without the feature 24, the other flow paths may be diverted by the first flow path 22. The feature 24 may limit interaction with other flow paths where necessary or may contribute to the other flow paths where necessary. The feature 24 utilizes the first flow path 22 generated as the vehicle 12 travels forward and does not need additional components to generate the first flow path 22.

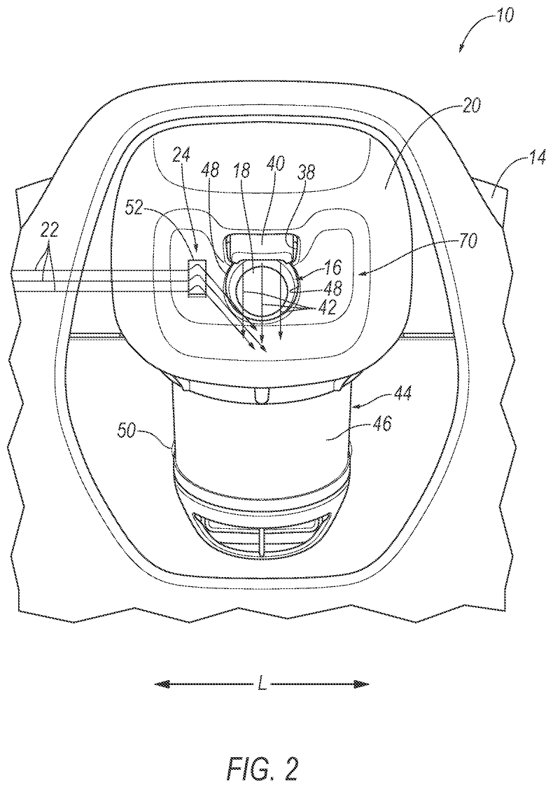

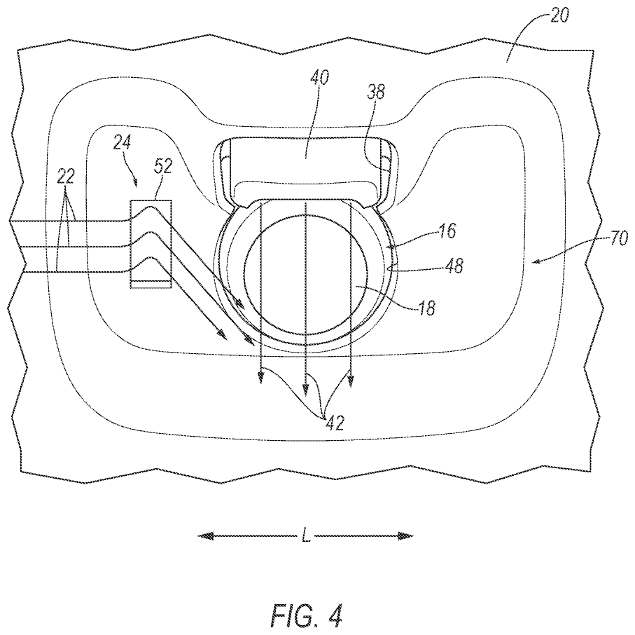

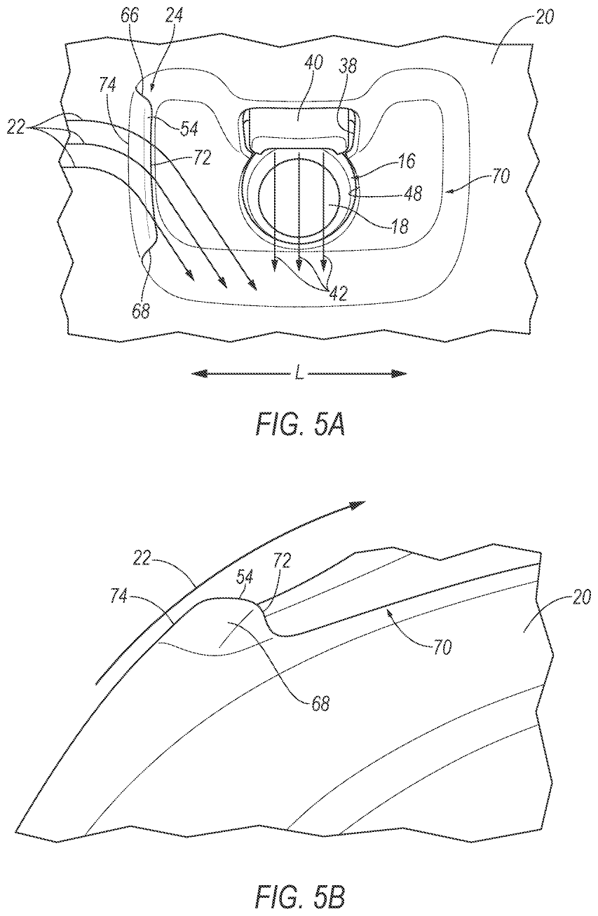

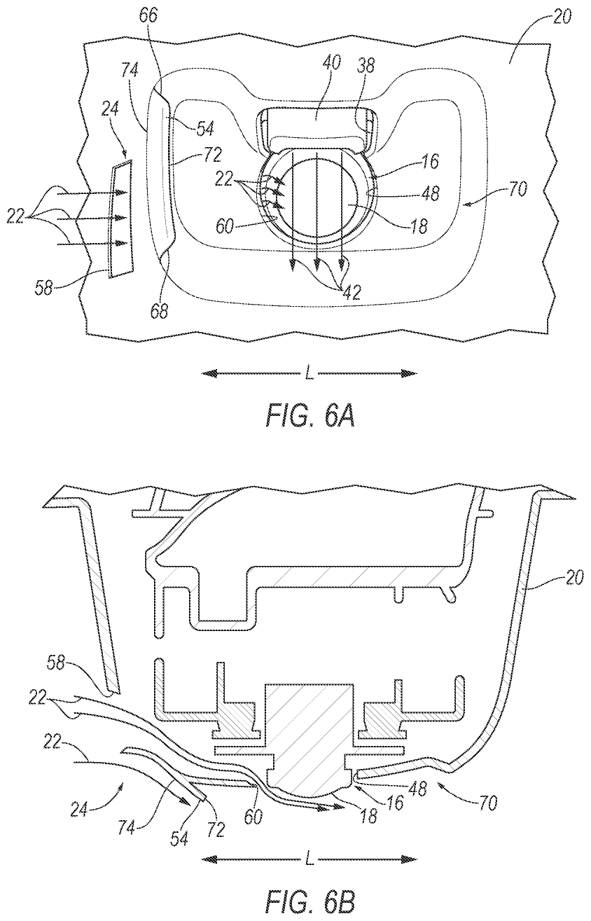

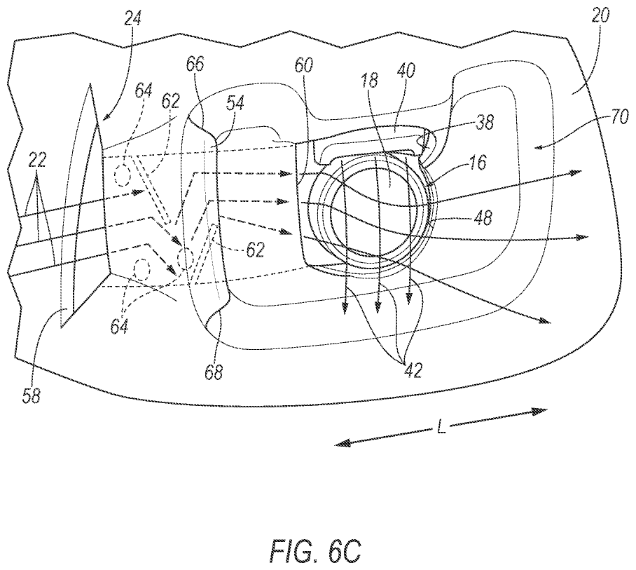

Three examples are shown in the Figures and common numerals are used to identify common features in the examples. One example of the assembly 10 is shown in FIGS. 2 and 4. In such an example, the feature 24 that diverts the first flow path 22 includes an opening 52 vehicle-forward of the sensor 16. The opening 52 allows airflow into and out of the opening 52 to divert the first flow path 22 away from the sensor 16. A second example of the assembly 10 is shown in FIGS. 5A-5B. In such an example the feature 24 that diverts the first flow path 22 includes a deflector 54 directed away from the sensor 16. A third example of the assembly 10 is shown in FIGS. 6A-6C. In such an example, the feature 24 that diverts the first flow path 22 includes a duct 56 directed toward the sensor 16 and a deflector 54 directed away from the sensor 16.

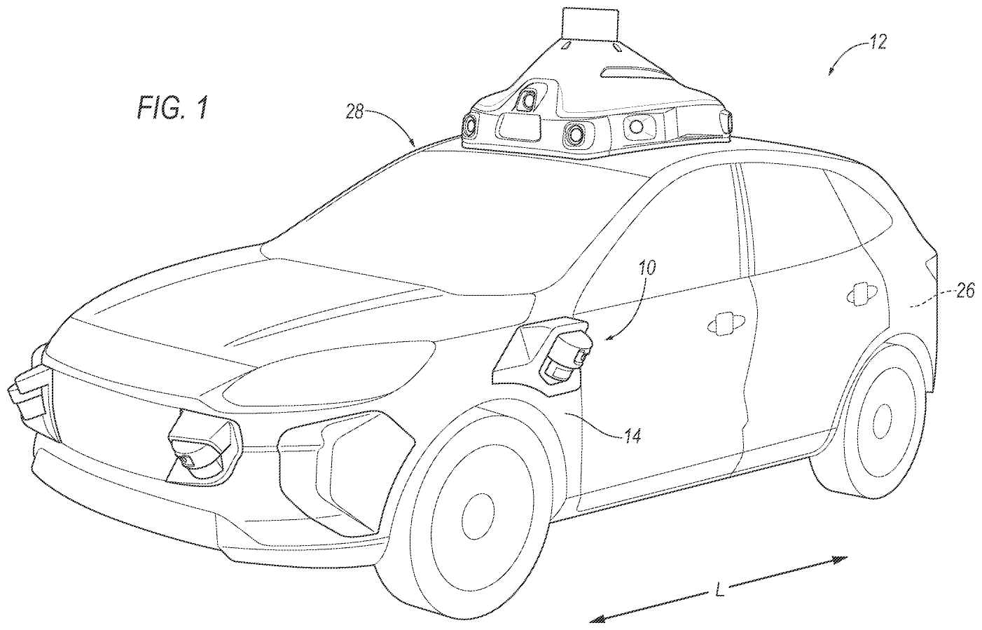

With reference to FIG. 1, the vehicle 12 may be any passenger or commercial automobile such as a car, a truck, a sport utility, a crossover, a van, a minivan, a taxi, a bus, etc.

The vehicle 12 includes a frame 26 and a body 28. The vehicle 12 may be of a unibody construction, in which the frame 26 and the body 28 of the vehicle 12 are a single component. The vehicle 12 may, alternatively, be of a body-on-frame construction, in which the frame 26 supports the body 28 that is a separate component from the frame 26. The frame 26 and body 28 may be formed of any suitable material, for example, steel, aluminum, etc.

The body 28 includes body panels 14 partially defining an exterior of the vehicle 12. The body panels 14 may include a vehicle fender, vehicle roof, vehicle hood, etc. The body panels 14 may present a class-A surface, e.g., a finished surface exposed to view by a customer and free of unaesthetic blemishes and defects.

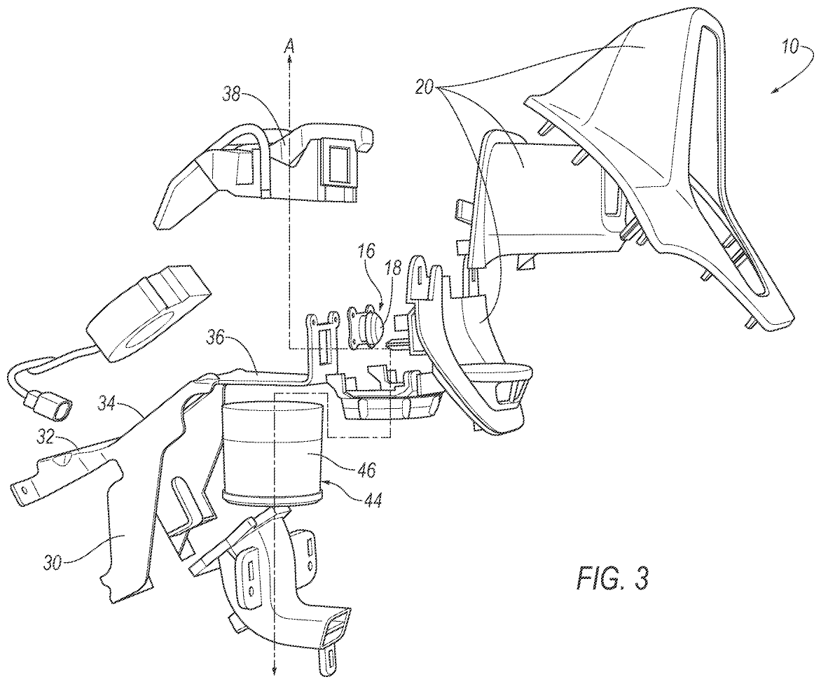

With reference to FIGS. 2-3, the assembly 10 includes the first sensor 16. The first sensor 16 may detect the external world, e.g., objects and/or characteristics of surroundings of the vehicle 12, such as other vehicles, road lane markings, traffic lights and/or signs, pedestrians, etc. For example, the first sensor 16 may be a radar sensor, an ultrasonic sensor, a scanning laser range finder, a light detection and ranging (LIDAR) device, an image processing sensor such as a camera, etc. In particular, the first sensor 16 may be a camera and may detect electromagnetic radiation in some range of wavelengths. For example, the first sensor 16 may detect visible light, infrared radiation, ultraviolet light, or some range of wavelengths including visible, infrared, and/or ultraviolet light. For example, the camera may be a charge-coupled device (CCD), complementary metal oxide semiconductor (CMOS), or any other suitable type. The first sensor 16 may include a sensor lens.

With reference to FIG. 3, the assembly 10 may include a bracket 30 and a frame 26 member (not numbered) of the frame 26. The bracket 30 may be fixed to the frame 26 member, for example, welded or fastened, e.g., bolted, riveted, etc.

The bracket 30 may include a first panel 32, a second panel 34 extending from the first panel 32, and a third panel 36 extending from the second panel 34. The first panel 32, second panel 34, and third panel 36 may each be generally flat. The first panel 32 and second panel 34 may extend transverse to each other, and the second panel 34 and third panel 36 may extend transverse to each other. The first panel 32 may be spaced from the third panel 36. The first panel 32 may be fixed to the frame 26 member, and the third panel 36 may be spaced from the frame 26 member. The second panel 34 may include a bracket opening.

The first sensor 16 is supported by the body panel 14. The first sensor 16 may be supported by the vehicle fender of the vehicle 12. The first sensor 16 may be mounted to the bracket 30. For example, the first sensor 16 may be fixed to the bracket 30 in any suitable way, e.g., snap features, fasteners, etc. The first sensor 16 may be positioned on an opposite side of the bracket 30, e.g., on an opposite side of the third panel 36 of the bracket 30 along an axis A, from the second sensor 44.

The first sensor 16 includes a first sensor window 18. The first sensor window 18 may be oriented to have a field of view of the external environment around the vehicle 12. The field of view may extend through the first sensor window 18. For example, when the first sensor 16 is a camera, the first sensor window 18 may be a lens.

The assembly 10 may include a cleaning device 38 spaced upwardly from the first sensor 16. The cleaning device 38 may include a cleaning nozzle 40 for cleaning the first sensor window 18 in the event of an obstruction, e.g., debris, dirt, water, etc., blocks or impedes any field of view of the first sensor window 18. The cleaning nozzle 40 may be directed toward the first sensor window 18 to remove an obstruction, e.g., debris, dirt, water, etc., from the first sensor window 18 during use of the vehicle 12. The cleaning nozzle 40 may be directed downwardly over the first sensor window 18. A cleaning flow path 42 may be directed by the cleaning nozzle 40 over the first sensor window 18 to remove any obstructions from the first sensor window 18. The cleaning flow path 42 is transverse to the first flow path 22. A cleaning liquid, e.g., air, water, other fluids, etc., may leave the cleaning nozzle 40 downwardly over the first sensor window 18 to remove any obstruction from the first sensor window 18.

Referring back to FIGS. 2-3, the assembly 10 may include a second sensor 44 spaced downwardly from the first sensor 16. The second sensor 44 may fixed to the bracket 30, e.g., fastened to the bracket 30. For example, the second sensor 44 may be fastened to the third panel 36 of the bracket 30 by a plurality of fasteners, e.g., a first fastener, a second fastener, and a third fastener. The second sensor 44 may hang below the third panel 36 of the bracket 30, i.e., may be positioned below the third panel 36 of the bracket 30 and be supported by the third panel 36 of the bracket 30. This position may reduce dimensional stackup by permitting more components to be attached to just one bracket 30.

The second sensor 44 includes a second sensor window 46. The second sensor window 46 may be oriented generally vertically, i.e., may extend up and down. The second sensor window 46 may be cylindrical and may define the axis A, which may be oriented generally vertically. The second sensor window 46 may extend around the axis A. The second sensor window 46 may extend fully around the axis A, i.e., 360°, or partially around the axis A. At least some of the second sensor window 46 may be transparent with respect to whatever medium the second sensor 44 is capable of detecting. For example, if the second sensor 44 is a LIDAR device, then the second sensor window 46 may be transparent with respect to visible light at the wavelength generated and detectable by the second sensor 44. The field of view of the second sensor 44 extends through the second sensor window 46.

The assembly 10 may include the cover 20 and one of the body panels 14 of the vehicle body 28. The cover 20 is fixed relative to the body panel 14 and extends from the body panel 14 in a direction away from the frame 26 member, i.e., extends outward from the rest of the vehicle 12, e.g., extends vehicle-outboard as the cover 20 is positioned on a side, i.e., vehicle fender, of the vehicle 12. The cover 20 may present a class-A surface, e.g., a finished surface exposed to view by a customer and free of unaesthetic blemishes and defects. The cover 20 may include one or multiple pieces.

The cover 20 is fixed relative to the first sensor 16 and the second sensor 44. For example, the cover 20 is disposed on and supported by one of the body panels 14. For example, the cover 20 may be attached to one of the body panels 14, e.g., snapped to the body panel 14, which is fixed relative to the frame 26. For example, as shown in the Figures, the cover 20 may be disposed on a front end of the vehicle 12 and supported by the vehicle fender, as shown in FIG. 1. While the discussion below is with respect to a single assembly 10, the vehicle 12 may include multiple assemblies 10, each with one cover 20 disposed on each side of the vehicle 12.

The cover 20 may be positioned to expose at least a portion of the first sensor window 18 of the first sensor 16 and a portion of the second sensor window 46 of the second sensor 44. For example, the cover 20 may include a first cover opening 48 that the first sensor 16 may extend into and a second cover opening 50 that the second sensor 44 may extend into. For example, the first sensor window 18 may extend into the first cover opening 48 and the second sensor window 46 may extend into the second cover opening 50. The first sensor 16 and the second sensor 44 may be positioned such that the remainder of the sensors 16, 44 may be concealed behind the cover 20, e.g., the remaining portion of the sensor 16 that is does not extend into the cover 20 openings 52. The second sensor window 46 may extend along the axis A from a bottom edge positioned at a bottom edge of the second cover opening 50 to a top edge positioned at a top edge of the second cover opening 50.

As the vehicle 12 travels forward, the vehicle 12 generates the first flow path 22 of ambient air along the vehicle-longitudinal axis L. In other words, as the vehicle 12 travels forward, the air around the vehicle 12 generates the first flow path 22 along the vehicle-longitudinal axis L. As shown in the Figures, because the assembly 10 is supported by a vehicle fender, the ambient air may move along the cover 20 along the vehicle-longitudinal axis L. The first flow path 22 of ambient air may flow transverse to the axis A, i.e., across the axis A.

While the vehicle 12 travels forward, the shape of the cover 20 may divert the first flow path 22 away from the first sensor window 18. The shape of the cover 20 includes the feature 24 that diverts the first flow path 22 while the vehicle 12 travels forward. As one example, the feature 24 may divert the first flow path 22 away from the first sensor window 18. Diverting the first flow path 22 away from the first sensor window 18 limits the interaction between the first flow path 22 and the cleaning flow path 42. In other words, the diverting of the first flow path 22 away from the first sensor window 18 allows the cleaning flow path 42 to continue to remove obstructions from the first sensor window 18 as the vehicle 12 travels forward. As another example, the feature 24 may divert the first flow path 22 toward the first sensor window 18. Diverting the first flow path 22 toward the first sensor window 18 allows the first flow path 22 and the cleaning flow path 42 to combine to provide additional cleaning of the first sensor window 18 as the vehicle 12 is in motion.

The feature 24 is spaced vehicle-forward of the first sensor window 18. In other words, the feature 24 may be spaced vehicle-forward of the first sensor window 18 along the vehicle-longitudinal axis L. Because the feature 24 is vehicle-forward of the first sensor window 18, the first flow path 22 may be diverted prior to reaching the first sensor window 18 and the cleaning flow path 42.

The cover 20 may define a depression 70. The depression 70 may be positioned upwardly of the second sensor 44 and face vehicle-outboard. In other words, the depression 70 faces away from the frame 26 of the vehicle 12. The first sensor 16 and the first sensor window 18 are disposed in the depression 70. The depression 70 may extend around the circumference of the first sensor 16 and the first sensor window 18. The depression 70 may slope vehicle-inboard and toward the frame 2. The depression 70 may be vehicle-inboard of an exterior panel of the cover 20.

As shown in the example of FIGS. 2 and 4, the feature 24 may include an opening 52. The opening 52 is positioned relative to the first sensor window 18 to divert the first flow path 22 as the vehicle 12 travels forward. As the first flow path 22 passes over the opening 52, the opening 52 diverts the first flow path 22 away from the first sensor window 18. By diverting the first flow path 22 away from the first sensor window 18, the opening 52 diverts the first flow path 22 away from the cleaning flow path 42 so as to limit interference with the cleaning flow path 42. The cleaning flow path 42 may continue to be directed toward the first sensor window 18 to remove obstructions from the first sensor window 18.

With continued reference to the example shown in FIGS. 2 and 4, the opening 52 is vehicle-forward of the first sensor window 18. The opening 52 being vehicle-forward of the first sensor window 18 allows the first flow path 22 to be diverted prior to the first flow path 22 reaching the first sensor window 18. The opening 52 extends vehicle-inboard, i.e., toward the frame 26. The opening 52 is positioned such that the first flow path 22 extends into the opening 52 and out of the opening 52 to divert the first flow path 22 away from the first sensor window 18 as the vehicle 12 travels forward. As the vehicle 12 is traveling forward, the first flow path 22 flows into the opening 52 and toward the frame 26. The first flow path 22 flows out of the opening 52 and away from the frame 26. The air flowing out of the opening 52 allows the first flow path 22 to be diverted away from the first sensor window 18. In one example, the opening 52 may be open to other components concealed by the cover 20. In other examples, the opening 52 may include a panel (not shown) to limit view of other components concealed by the cover 20.

As shown in the example of FIGS. 5A-5B, the feature 24 includes a deflector 54. The deflector 54 may be shaped to direct airflow away from the first sensor 16. In other words, the deflector 54 is shaped to divert airflow away from the first sensor window 18 as the vehicle 12 travels forward. The deflector 54 may divert the first flow path 22 away from first sensor window 18. The diversion of the first flow path 22 away from the cleaning flow path 42 may limit interference by the first flow path 22 with the cleaning flow path 42. The airflow may be generated as the vehicle 12 travels forward. For example, the deflector 54 may be elongated generally vertically from a top end 66 to a bottom end 68. The top end 66 may be positioned vertically above a highest point of the first sensor window 18, and the bottom end 68 may be positioned below a lowest point of the first sensor window 18. The deflector 54 has a generally constant cross-section from the top end 66 to the bottom end 68. The cross-section is taken orthogonal to the direction of elongation of the deflector 54. The cross-section may slope vehicle-outboard in a vehicle-rearward direction, i.e., a vehicle-rearward edge 72 of the deflector 54 may be further vehicle-outboard than a vehicle-forward edge 74 of the deflector 54. A slope of the deflector 54 may decrease from the vehicle-forward end to the vehicle-rearward end. The deflector 54 may have a smoothly curving shape from the vehicle-forward end to the vehicle-rearward end, i.e., a shape without sharp corners.

With continued reference to the example shown in FIGS. 5A-5B, the deflector 54 is fixed relative to the first sensor 16 and the first sensor window 18. The deflector 54 may be positioned vehicle-forward of the first sensor window 18. The deflector 54 may be vehicle-forward of the depression 70 surrounding the first sensor 16 and the first sensor window 18. The first flow path 22 may flow over the deflector 54 as the vehicle 12 travels forward to divert the first flow path 22 away from the first sensor window 18.

As shown in the example of FIGS. 6A-6C, the feature 24 may include a duct 56. The duct 56 may be elongated along the vehicle-longitudinal axis L. In examples including the duct 56, the duct 56 is directed toward the first sensor window 18 of the first sensor 16. The duct 56 being directed toward the first sensor window 18 allows the first flow path 22 to be combined with the cleaning flow path 42. The combination of the first flow path 22 and the cleaning flow path 42 may remove obstructions from the first sensor window 18.

As discussed above, the duct 56 may be elongated along the vehicle-longitudinal axis L. The duct 56 defines an inlet 58 vehicle-forward along the vehicle-longitudinal axis L of the first sensor window 18 from the first sensor window 18. The duct 56 defines an outlet 60 directed toward the first sensor window 18. The inlet 58 is spaced vehicle-forward of the first sensor window 18. As the vehicle 12 is in motion, the first flow path 22 flows into the inlet 58 and out of the outlet 60. In other words, the inlet 58 is positioned to receive the first flow path 22 as the vehicle 12 travels forward. The outlet 60 is positioned adjacent the first sensor window 18. The outlet 60 is between the inlet 58 and the sensor window 18 along the vehicle-longitudinal axis L. The outlet 60 is positioned such that the first flow path 22 exits the duct 56 through the outlet 60 and the first flow path 22 is diverted by the outlet 60 toward the first sensor window 18. In other words, as the first flow path 22 flows through the duct 56 and out of the outlet 60, the first flow path 22 is directed toward the first sensor window 18 to combine with the cleaning flow path 42 to clean the first sensor window 18.

With continued reference to the example shown in FIGS. 6A-6C, the duct 56 is between the cover 20 and the body panel 14 and frame 26. The duct 56 is concealed behind the cover 20 to allow the first flow path 22 to flow through the duct 56. In other words, the duct 56 extends vehicle-inboard of the exterior panel of the cover 20.

With reference to FIG. 6C, between the cover 20 and the body panel 14, the duct 56 includes one or more walls 62 to divert the first flow path 22 through the duct 56 and toward the first sensor window 18. The walls 62 may change direction of the first flow path 22. The walls 62 may be spaced from each other along the vehicle-longitudinal axis L between the inlet 58 and the outlet 60. The walls 62 may be elongated in respective directions transverse to the vehicle-longitudinal axis L and transverse to each other. In the example show in FIG. 6C, the duct 56 includes two walls 62 spaced from each other along the vehicle-longitudinal axis L between the inlet 58 and the outlet 60.

With continued reference to the example shown in FIGS. 6A-6C, the assembly 10 may include one or more baffles 64 disposed in the duct 56 between the inlet 58 and the outlet 60. The baffles 64 may be positioned along the duct 56 to absorb humidity from the first flow path 22 as the first flow path 22 flows from the inlet 58 to the outlet 60. The baffles 64 may be of any suitable material such that the baffles 64 absorb humidity, e.g., foam, sponge, etc.

The example shown in FIGS. 6A-6C includes a combination of the duct 56 and the deflector 54. The deflector 54 is identical to the deflector 54 described above and shown in FIGS. 5A-5B. The deflector 54 and the duct 56 may split the first flow path 22 to have a portion of the first flow path 22 flow over the first sensor window 18 and a portion of the first flow path 22 flow diverted away from the first sensor window 18. The feature 24 of the assembly 10 may include any suitable combination of the above elements to divert the ambient air away from or toward the first sensor window 18.

The disclosure has been described in an illustrative manner, and it is to be understood that the terminology which has been used is intended to be in the nature of words of description rather than of limitation. The adjectives “first,” “second,” and “third” are used throughout this document as identifiers and are not intended to signify importance, order, or quantity. Many modifications and variations of the present disclosure are possible in light of the above teachings, and the disclosure may be practiced otherwise than as specifically described.

What is claimed is:

1. An assembly comprising:
a body panel of a vehicle;
a sensor supported by the body panel, the sensor including a sensor window; and
a cover fixed relative to the sensor, the cover being positioned to expose at least a portion of the sensor window;
the cover being shaped to include a feature that diverts a first flow path of ambient air while the vehicle travels forward, the first flow path being generated along a vehicle longitudinal axis when the vehicle travels forward.

2. The assembly of claim 1, wherein the feature is spaced vehicle-forward of the sensor window.

3. The assembly of claim 1, wherein the cover defines a depression, the sensor and the feature being disposed in the depression.

4. The assembly of claim 1, wherein the feature includes an opening vehicle-forward of the sensor window, and the opening is positioned relative to the sensor window to divert the first flow path while the vehicle travels forward.

5. The assembly of claim 4, wherein the opening is positioned such that the first flow path extends into the opening and out of the opening to divert the first flow path away from the sensor window while the vehicle travels forward.

6. The assembly of claim 1, wherein the feature includes a deflector fixed relative to the sensor and spaced vehicle-forward of the sensor, the deflector being shaped to divert the first flow path away from the sensor window while the vehicle travels forward.

7. The assembly of claim 1, wherein the feature includes a duct elongated along the vehicle-longitudinal axis, the duct defining an inlet vehicle-forward of the sensor window along the vehicle-longitudinal axis and an outlet directed toward the sensor window, the inlet positioned to receive the first flow path.

8. The assembly of claim 7, wherein the outlet is positioned to divert the first flow path.

9. The assembly of claim 7, wherein the cover is supported by the body panel, the duct being between the cover and the body panel.

10. The assembly of claim 7, further comprising a baffle disposed in the duct between the inlet and the outlet.

11. The assembly of claim 7, wherein the outlet is adjacent the sensor window.

12. The assembly of claim 7, wherein the inlet is spaced vehicle-forward of the sensor window.

13. The assembly of claim 7, wherein the outlet is between the inlet and the sensor window along the vehicle-longitudinal axis.

14. The assembly of claim 7, wherein the feature includes a deflector fixed relative to the sensor and spaced vehicle-forward of the sensor, the deflector being shaped to divert airflow away from the sensor window while the vehicle travels forward.

15. The assembly of claim 1, wherein the cover is supported by the body panel.

16. The assembly of claim 1, wherein the body panel is a vehicle fender.

17. The assembly of claim 1, wherein the sensor is a camera.

18. The assembly of claim 1, wherein the feature diverts the first flow path away from the sensor window.

19. The assembly of claim 1, wherein the feature diverts the first flow path toward the sensor window.

20. The assembly of claim 1, further comprising a cleaning device defining a cleaning flow path, the first flow path being transverse to the cleaning flow path.
